(19) United States
(12) Patent Application Publication
(10) Pub. No.: US 2026/0110626 A1
(43) Pub. Date: Apr. 23, 2026

(54) Ellipsometric Imaging For Optical Defect Inspection

(71) Applicant: KLA Corporation, Milpitas, CA (US)

(72) Inventors: Kuljit Virk, Fremont, CA (US); Abdurrahman Sezginer, Monte Sereno, CA (US); John Schweyen, San Jose, CA (US)

(21) Appl. No.: 19/290,301

(22) Filed: Aug. 4, 2025

Related U.S. Application Data
(60) Provisional application No. 63/708,944, filed on Oct. 18, 2024.

(51) Int. Cl. G01N 21/21; G01N 21/23; G01N 21/47; G01N 21/88; G01N 21/95; G01N 21/956

(52) U.S. Cl. CPC G01N 21/211; G01N 21/23; G01N 21/47; G01N 21/8806; G01N 21/9501; G01N 21/956; G01N 2021/8848; G01N 2021/95676; G01N 2201/0683

(57) ABSTRACT

Methods and systems for generating bright-field ellipsometric images indicative of structural defects sized below the optical resolution limit are presented herein. In some examples, bright-field ellipsometric images offer a higher signal to noise ratio of small defect signals to nuisance pattern noise signals compared to dark-field imaging at the null condition. Various ellipsometric imaging techniques are employed to generate images of a wafer or reticle under inspection. The images provide intensity contrast that is indicative of phase differences induced by the scattering response of different structures in the imaging field of the ellipsometric imaging system. In one aspect, an ellipsometric imaging system employs a polarizer in the illumination path and an analyzer and at least one waveplate in the imaging path. The ellipsometric imaging system generates images having intensity differences that differentiate defects of interest from nuisance pattern noise with relatively high signal to noise ratio.

### CROSS REFERENCE TO RELATED APPLICATION

The present application for patent claims priority under 35 U.S.C. § 119 from U.S. provisional patent application Ser. No. 63/708,944 entitled “Optical Defect Inspection by Ellipsometric Imaging,” filed Oct. 18, 2024, the subject matter of which is incorporated herein by reference in its entirety.

### TECHNICAL FIELD

The described embodiments relate to optical inspection of defects in structures fabricated on semiconductor wafers and lithographic reticles.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Inspection processes are used at various steps during a semiconductor manufacturing process to detect defects on wafers to promote higher yield. As design rules and process windows continue to shrink in size, inspection systems are required to capture a wider range of physical defects on wafer surfaces while maintaining high throughput.

In general, optical wafer inspection involves collecting images of a wafer and detecting irregularities in the detected images. Typically, a semiconductor wafer includes multiple die, fabricated adjacent to one another. In a perfect manufacturing scenario, each die are identical, and thus, the wafer image should have a perfect periodic structure. Irregularities detected in the wafer image are caused by defects in the periodic structure of the wafer. These defects are targets of the wafer inspection.

The collected wafer image is affected by noise and is therefore never perfectly periodic. Some noise is introduced by imperfections of the wafer inspection tool. In addition, a significant source of measurement noise is actual wafer defects that do not have a significant impact on the functionality of the manufactured semiconductor device. These insignificant defects are commonly referred to as “nuisance” defects. Other defects do have a significant impact on the functionality of the manufactured semiconductor device. These significant defects are commonly referred to as “defects of interest” (DOI).

In practice, optical inspection is used to find small, isolated defects on lithographic reticles (photomasks) and semiconductor wafers. Typically, the wavelength of illumination light employed to image a sample is 190 nanometers, or longer. The optical diffraction limit dictates that the smallest resolvable distance between two points using a conventional microscope is never smaller than half the wavelength of the imaging light. However, in some examples, defect sizes range in size from 5 nanometers to 50 nanometers. Thus, it is not possible to optically resolve defects sized in a range from 5-50 nanometers or the underlying semiconductor device pattern because the wavelength of the imaging light is significantly larger than the underlying feature size.

Although it is not possible to resolve defects having dimensions significantly smaller than the wavelength of the imaging light, small defects are photometrically detected based on the image intensity in the vicinity of the defect. The presence of a small defect alters the image intensity in the vicinity of the defect, which is detectable in an image generated by imaging light characterized by a wavelength significantly larger than the dimensions of the defect.

The sensitivity of photometrically based detection of defects is limited by random variations in the pattern of the semiconductor device, or corresponding reticle feature employed to define the geometry of the semiconductor device. Line-edge roughness and surface roughness of semiconductor devices are on the order of 1 nanometer. Although, pattern randomness having a dimension on the order of one nanometer will not be resolved in an inspection image, pattern randomness also alters local image intensity. As such, it is critically important to be able to distinguish image intensity variations due to small defects of interest and acceptable random variations in pattern geometry.

U.S. Patent Publication Nos. 2014/0204202 and 2014/0232849 by Ogawa et al., propose a dark-field imaging technique to perform image based inspection for defects sized below the resolution limit. The content of these applications is incorporated herein by reference in its entirety. In these disclosures, the illumination light is linearly polarized and an analyzer is located in the imaging path. The polarizer angle and the analyzer angle are set to minimize the image intensity in the absence of a defect, i.e., a defect free image is dark. This setting is referred to as the “null condition.” A defect is imaged as a bright spot on the dark background.

Similarly, U.S. Patent Publication Nos. 2018/0073979 and 20190113463, and “Super-contrast-enhanced darkfield imaging of nano objects through null ellipsometry,” Optics Letters, Vol. 43, Issue 23, pp. 5701-5704 (2018) by Cho et al. propose another dark-field imaging technique to perform image based inspection for defects sized below the resolution limit. The content of these references is incorporated herein by reference in its entirety. In these disclosures, the illumination light is linearly polarized and a waveplate and a polarizer are located in the imaging path. The waveplate and imaging polarizer are adjusted to achieve the “null condition.”

Although dark-field imaging at the null condition offers some advantages for imaging small defects, the ratio of defect signal to pattern noise is very low. Thus, dark-field imaging at the null condition does not offer a suitable solution for distinguishing small defects of interest from nuisance defects induced by pattern noise.

In general, the goal of wafer inspection is to capture as many defects of interest as possible and as few nuisance defects as possible. Over time, wafer inspection tools have evolved in an on-going effort to boost DOI visibility and suppress nuisance defects. However, improvements to wafer inspection systems are desired to gather additional signal information useful for improving sensitivity to DOIs, and distinguishing between DOIs and nuisance defects.

### SUMMARY

Methods and systems for generating bright-field ellipsometric images indicative of structural defects sized below the optical resolution limit are presented herein. In some examples, bright-field ellipsometric images offer a higher signal to noise ratio of small defect signals to nuisance pattern noise signals compared to dark-field imaging at the null condition. Various ellipsometric imaging techniques are employed to generate images of a wafer or reticle under inspection. The images provide intensity contrast that is indicative of phase differences induced by the scattering response of different structures in the imaging field of the ellipsometric imaging system.

In one aspect, an ellipsometric imaging system employs a polarizer in the illumination path and an analyzer and at least one waveplate in the imaging path. The ellipsometric imaging system generates images having intensity differences that are indicative of the phase differences induced by the scattering response of different structures in the imaged field. Moreover, these phase differences allow differentiation of defects of interest from nuisance pattern noise with relatively high signal to noise ratio.

In some embodiments, an ellipsometric imaging system includes a waveplate and an analyzer in the imaging path of the imaging system. In some of these embodiments, the waveplate has an adjustable retardance and adjustable clocking angle.

In some other embodiments, an ellipsometric imaging system includes two waveplates and an analyzer in the imaging path. The waveplates each have a different, fixed retardance and adjustable clocking angle.

In some other embodiments, an ellipsometric imaging system includes three waveplates and an analyzer in the imaging path. The waveplates each have a different, fixed retardance and adjustable clocking angle.

In some other embodiments, an ellipsometric imaging system includes two waveplates interspersed among three optical retarders in the imaging path. Each of the optical retarders has an adjustable retardance. The waveplates each have a fixed retardance. In some embodiments, the waveplates are quarter waveplates each having a different retardance. Furthermore, the waveplates each have a fixed, non-adjustable clocking angle.

In some embodiments, an ellipsometric imaging system generates linearly polarized illumination light incident on a specimen under inspection. In some other embodiments, an ellipsometric imaging system generates circularly polarized illumination light incident on a specimen under inspection.

In a further aspect, the adjustable system parameters of an ellipsometric imaging system are optimized to provide the highest defect signal to wafer noise ratio.

In preferred embodiments, an ellipsometric imaging system is configured to image a field plane conjugate to the surface of the specimen under inspection onto the surface of an imaging detector.

In some other embodiments, an ellipsometric imaging system is configured to image a pupil plane conjugate to the surface of the specimen under inspection onto the surface of an imaging detector.

In a further aspect, an ellipsometric imaging system is configured to identify one or more defects of interest on the imaged specimen over the imaged area based on the intensity values of the detected image, and determine a map of defect locations. In some embodiments, one or more defects of interest on the imaged specimen over the imaged area are identified based on a comparison of each intensity value and a predetermined threshold value.

In another further aspect, one or more defects of interest on the imaged specimen over the imaged area are identified based on a difference image. The difference image is a pixel by pixel difference between the detected image and a defect-free reference image. In this manner, signal contrast is enhanced.

In some examples, a defect-free, reference image is generated by averaging the pixel intensities associated with a large number of images each collected from different instances of a specimen. In these examples, the presence of a defect at a particular pixel location is relatively rare.

Defect detection of some objects is enhanced based on differential images because the differences between images of the same location are highlighted in a differential image. The enhancement of defect detection is particularly apparent when measurement conditions, such as environmental conditions at the wafer, measurement system configuration, etc., are changed between measurements.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified diagram illustrative of an embodiment of an ellipsometric imaging system 100 useful for defect inspection of semiconductor wafers and reticles.

FIG. 2 is a simplified diagram illustrative of an inspection location within the field of view of an imaging detector at an instant in time.

FIG. 3 is a simplified diagram illustrative of inspection locations associated with the fields of view of three different imaging detectors.

FIG. 4 is a simplified diagram illustrative of a surface of the detector depicted in FIG. 1.

FIG. 5 is a simplified diagram illustrative of another embodiment of an ellipsometric imaging system 200 useful for defect inspection of semiconductor wafers and reticles.

FIG. 6 is a simplified diagram illustrative of another embodiment of an ellipsometric imaging system 300 useful for defect inspection of semiconductor wafers and reticles.

FIG. 7 is a simplified diagram illustrative of another embodiment of an ellipsometric imaging system 400 useful for defect inspection of semiconductor wafers and reticles.

FIG. 8 is an image of a line/space grating including a defect of interest.

FIG. 9A is an image of the line/space grating depicted in FIG. 8 as collected by an imaging system with horizontal illumination polarization (x-polarization only) and no waveplate and no analyzer in the imaging path.

FIG. 9B is an image of the line/space grating depicted in FIG. 8 as collected by the ellipsometric imaging system depicted in FIG. 1.

FIG. 10 is a flowchart illustrative of a method of performing defect inspection based on ellipsometric images as presented herein.

### DETAILED DESCRIPTION

Reference will now be made in detail to background examples and some embodiments of the invention, examples of which are illustrated in the accompanying drawings.

Methods and systems for generating bright-field ellipsometric images indicative of structural defects sized below the optical resolution limit are presented herein. In some examples, bright-field ellipsometric images offer a higher signal to noise ratio of small defect signals to nuisance pattern noise signals compared to dark-field imaging at the null condition.

The state of fully polarized light and interactions with optical elements can be described using Jones calculus. The magnitude and phase of the electric field associated with polarized light propagating in a homogeneous, isotropic medium with negligible attenuation is represented by a Jones vector illustrated by Equation (1). Eₓₓ and E_{yy} are the x and y components of the electric field, E, respectively, where x and y are Cartesian coordinates defining a plane perpendicular to the direction of propagation of the beam of light.

$$E = ( \begin{matrix}{E}_{xx} \\ {E}_{yy}\end{matrix} ) \qquad ( 1 )$$

An optical element interacting with incident polarized light is represented by a Jones matrix. The product of the Jones matrix representing the optical element and the Jones vector representing the incident light predicts the resulting magnitude and phase of the electric field associated with light scattered from the optical element. A Jones matrix is commonly represented as a four element matrix as illustrated in Equation (2). The term, Sₓₓ, is the operator associated with the transformation of the magnitude and phase of the incident electric field in the x-direction to the magnitude and phase of the scattered electric field in the x-direction. Similarly, the term, S_{yy}, is the operator associated with the transformation of the magnitude and phase of the incident electric field in the y-direction to the magnitude and phase of the scattered electric field in the y-direction. The terms, S_{xy} and S_{yx}, are cross-polarization terms. S_{xy} and S_{yx} are operators associated with the transformation of the magnitude and phase of the incident electric field in the x-direction to the magnitude and phase of the scattered electric field in the y-direction, and vice-versa.

$$S = ( \begin{matrix}{S}_{xx} & {S}_{xy} \\ {S}_{yx} & {S}_{yy}\end{matrix} ) \qquad ( 2 )$$

For purposes of reticle and wafer inspection, a defect of interest and nuisance pattern noise structures can each be represented by a different scattering matrix. The differences in properties of these scattering matrices offer clues as to how light scattered from a defect of interest can be distinguished from light scattered from nuisance pattern noise structures.

The inventors have discovered that the ratio of the magnitudes of the scattering matrix component terms, |S_{yy}|/|Sₓₓ|, associated with defects of interest and pattern noise structures exhibit little difference. However, the phase of the complex ratio, S_{yy}/Sₓₓ, associated with defects of interest and pattern noise structures is significantly different. For this reason, the inventors propose various ellipsometric imaging techniques to generate images of the wafer or reticle under inspection. The images generated by the proposed ellipsometric imaging techniques described herein provide intensity contrast that is indicative of phase differences induced by the scattering response of different structures in the imaging field of the ellipsometric imaging system.

In one aspect, an ellipsometric imaging system employing a polarizer in the illumination path and an analyzer and at least one waveplate in the imaging path is configured to generate a bright-field image indicative of the phase differences associated with scattering from small defects of interest and nuisance pattern noise. The ellipsometric imaging system generates images having intensity differences that are indicative of the phase differences induced by the scattering response of different structures in the imaged field. Moreover, these phase differences allow differentiation of defects of interest from nuisance pattern noise with relatively high signal to noise ratio.

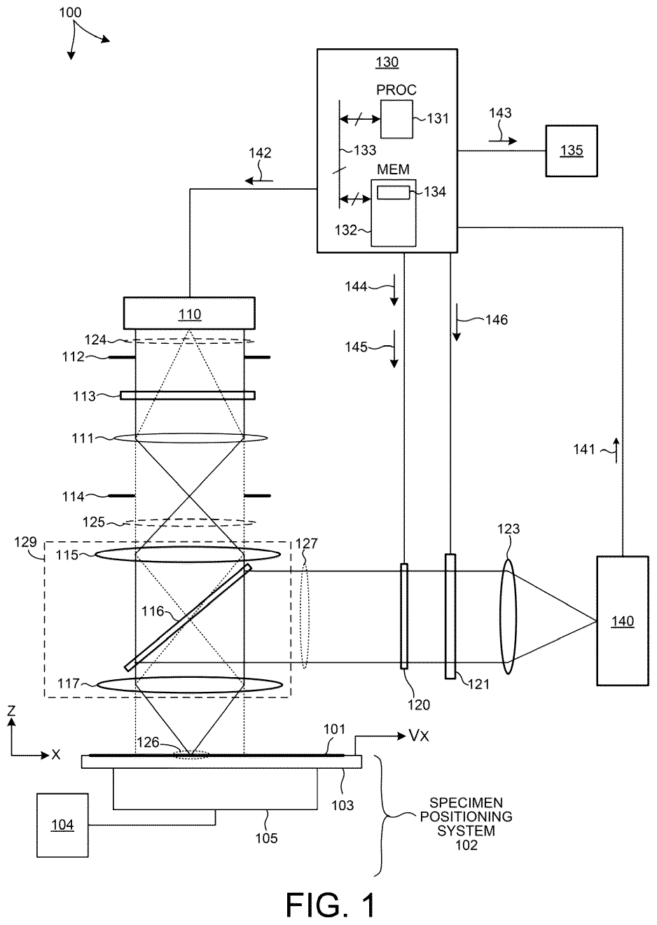

FIG. 1 is a simplified diagram illustrative of an embodiment of an ellipsometric imaging system 100 useful for defect inspection of semiconductor wafers and reticles. Ellipsometric imaging system 100 includes a waveplate having adjustable retardation and an analyzer in the imaging path of the imaging system. For simplification, some optical components of the system have been omitted. By way of example, folding mirrors, polarizers, beam forming optics, additional light sources, additional collectors, and detectors may also be included. All such variations are within the scope of the invention described herein. The inspection system described herein may be used for inspecting patterned wafers and reticles.

As illustrated in FIG. 1, ellipsometric imaging system 100 includes an illumination source 110. Illumination source 110 may include, by way of example, a laser driven plasma light source, a laser, a diode laser, a helium neon laser, an argon laser, a solid state laser, a diode pumped solid state (DPSS) laser, a xenon arc lamp, a gas discharging lamp, an LED array, or an incandescent lamp. The light source may be configured to emit near monochromatic light or broadband light. In a preferred embodiment, illumination source 110 is a monochromatic light source emitting light having a peak wavelength of 190 nanometers. In some embodiments, illumination source 110 includes a combination of multiple light sources. In some embodiments, illumination source 110 includes one or more spatially and temporally coherent, high-brightness illumination sources. A coherent, high-brightness illumination source enables high spectral intensity, and thus good signal to noise ratio.

As depicted in FIG. 1, ellipsometric imaging system 100 includes an illumination subsystem configured to direct illumination light 124 through the illumination subsystem. The resulting polarized illumination light 125 propagates through objective 129 onto inspection location 126 on the surface of specimen 101.

As depicted in FIG. 1, the illumination subsystem includes illumination source 110, pupil stop 112, polarizing component 113, beam shaping optics 111, and field stop 114. As depicted, in FIG. 1, the beam of illumination light 124 is focused by beam shaping optics 111. The focused light passes through pupil stop 112, polarizing component 113, and illumination field stop 114 as the beam propagates from the illumination source 110 to objective 129.

In the embodiment depicted in FIG. 1, pupil stop 114 controls the numerical aperture of the illumination at the wafer (NA_{ILL}) and may include any suitable commercially available aperture stop. The illumination field stop controls the field of view (FOV) of the illumination subsystem and may include any suitable commercially available field stop.

In general, the illumination subsystem may include any type and arrangement of optical filter(s), polarizing component, field stop, pupil stop, etc., known in the art of ellipsometry. In addition, the illumination subsystem may include filters, masks, apodizers, etc. For example, the illumination subsystem may include one or more optical filters (not shown). The optical filters are employed to control light level, spectral output, or both, from the illumination subsystem. In some examples, one or more multi-zone filters are employed as optical filters. In some embodiments, beam shaping optics 111 include one or more optical elements having reflective focusing power.

In some examples, noise and polarization optimization are performed to improve the performance of illumination source 110. In some examples, depolarization is achieved by use of multimode fibers, a Hanle depolarizer, or an integration sphere. In some examples, the illumination source etendue is optimized by use of light guides, fibers, and other optical elements (e.g., lenses, curved mirrors, apodizers, etc.).

Polarizing component 113 generates the desired polarization state exiting the illumination subsystem. In some embodiments, the polarizing component includes a polarizer, a compensator, or both, and may include any suitable commercially available polarizing component. The polarizer, compensator, or both, can be fixed, or rotatable to different fixed positions. Although the illumination subsystem depicted in FIG. 1 includes one polarizing component, the illumination subsystem may include more than one polarizing component. In some embodiments, a polarizer of polarizing component 113 is a Magnesium Fluoride Rochon polarizer. In some embodiments, a compensator of polarizing component 113 includes a quartz waveplate, a Magnesium Fluoride waveplate, a Calcium Fluoride K-prism, a Calcium Fluoride double Fresnel rhomb, or any combination thereof. In some embodiments, a compensator of polarizing component 113 includes one or more waveplates.

In a preferred embodiment, polarizing component 113 is rotatable, and is adjusted to provide linear polarization at 45 degrees. In this manner, illumination light includes both x and y components in equal measure.

As depicted in FIG. 1, objective 129 includes lenses 115 and 118, and beam splitting element 116. In some embodiments, the elements of objective 129 are integrated into a single opto-mechanical package. Objective 129 focuses illumination beam 125 onto inspection location 126.

Ellipsometric imaging system 100 also includes a collection optics subsystem configured to collect light generated by the interaction between the one or more structures and the incident illumination beam 125 and project an image on the surface of detector 140.

As depicted in FIG. 1, objective 129 collects light 127 from inspection location 126 in response to the incident illumination light and directs the collected light toward imaging detector 140. Collected light 127 passes through waveplate 120, analyzer 121, and collection focusing optics 123 of the collection optics subsystem as the beam of collected light 127 propagates from specimen 101 to detector 140. In some embodiments, focusing optics 123 includes a tube lens. In some other embodiments, focusing optics 123 include a set of one or more optics having reflective focusing power.

The collection optics subsystem may include any type and arrangement of optical filter(s), waveplate, analyzing component, field stop, pupil stop, etc., known in the art of ellipsometry. In general, a collection optics subsystem includes at least one waveplate, an analyzer, and one or more optical elements having focusing power. In some embodiments, one or more collection optical elements include image filter elements that limit the range of wavelengths of light directed to imaging detector 140. The image filter elements may be bandpass filters and/or edge filters and/or notch filters.

As depicted in FIG. 1, the collection optics subsystem includes a rotatable waveplate 120 having adjustable retardance. In some embodiments, retardance is adjustable electronically, e.g., a liquid crystal variable retarder. In some other embodiments, retardance is adjustable mechanically, e.g., a wedge waveplate having adjustable wedge angle. Waveplate 120 is also rotatable to a desired clocking angle with respect to the direction of propagation of collected light 127 through waveplate 120, i.e., orientation angle of waveplate 120 about an axis aligned with the direction of propagation of collected light 127 passing through waveplate 120.

The collection optics subsystem includes an analyzer 121 that analyzes the polarization state of the collected light after passing through waveplate 120. Analyzer 121 is rotatable to a desired clocking angle with respect to the direction of propagation of collected light 127 through analyzer 121.

In preferred embodiments, the waveplate 120 and analyzer 121 are located at or near a field plane of the collection optics subsystem conjugate to the surface of specimen 101. In these embodiments, the combination of waveplate 120 and analyzer 121 creates interference between phases of the x and y components of the electric field of collected light 127 at each location in the field plane, i.e., at each different location within the image of the wafer surface. In some examples, the wafer surface is defined in two dimensions by x and y Cartesian coordinates. In these embodiments, collection focusing optics 123 images the field plane onto the surface of detector 140. In these embodiments, focusing optics 123 images the field plane according to the x-position coordinate across the active surface of the detector along one direction, and images the field plane according to the y-position coordinate across the active surface of the detector along another direction, orthogonal to the first direction. The range of x and y positions imaged across the detector is defined by the collection field of view.

As such, focusing optics 123 maps the interference phase pattern in the field plane to intensities on the surface of detector 140. In this manner, the intensity pattern of the detected image is indicative of the phase interference between Eₓₓ and E_{yy} at measured location at specimen 101. The intensity pattern is different for defects of interest and regular, patterned structures.

In these embodiments, detector 140 resolves the collected light into discrete x-position locations on the active surface of detector 140 along one direction and resolves the collected light into discrete y-position locations along another direction. In a preferred embodiment, the x-position and y-position directions are orthogonal.

In some other embodiments, waveplate 120 and analyzer 121 are located at or near a pupil of the collection optics subsystem. In these embodiments, the combination of waveplate 120 and analyzer 121 creates interference between phases of the x and y components of the electric field of collected light 127 at each location in the pupil plane, i.e., at each different location within the collection NA. In some examples, the collection NA is defined in two dimensions by the angle of incidence and azimuth angle of the collected light. In these embodiments, collection focusing optics 123 image the pupil plane onto the surface of detector 140. As such, beam shaping optics 123 maps the interference phase pattern in the pupil plane to intensities on the surface of detector 140. In this manner, the intensity pattern of the detected image is indicative of the phase interference between Eₓₓ and E_{yy} at each collection angle from specimen 101. The intensity pattern is different for defects of interest and regular, patterned structures.

In these embodiments, focusing optics 123 images the pupil plane according azimuth angle across the active surface of the detector along one direction, and images the pupil plane according to angle of incidence across the active surface of the detector along another direction, orthogonal to the first direction. The range of azimuth angles and angles of incidence imaged across the detector is defined by the collection NA.

In these embodiments, the detector resolves the collected light into discrete azimuth angles on the active surface of detector 140 along one direction and resolves the collected light into discrete angles of incidence along another direction. In a preferred embodiment, the azimuth and angle of incidence directions are orthogonal.

As depicted in FIG. 1, ellipsometry imaging system 100 includes at least one detector, e.g., detector 140, having a planar, two-dimensional surface sensitive to incident light. Detector 140 is selected for signal to noise ratio performance and fast read-out. Detector 140 detects the amount of collected light and generates output signals 141 indicative of the detected light.

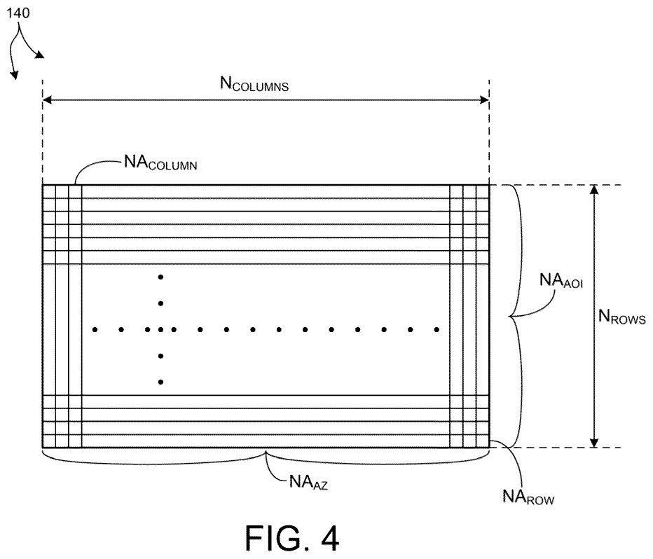

FIG. 4 is a simplified diagram illustrative of a surface of detector 140 depicted in FIG. 1. The pixels of detector 140 are arranged in a two dimensional array extending in the horizontal and vertical directions relative to the drawing page. Detector 140 includes a number of columns, N_{COLUMNS}, and a number of rows, N_{ROWS}. In some embodiments, detector 140 includes 1,000-5,000 columns and 100-200, or more, rows. As illustrated in FIG. 4, collected light is dispersed across detector 140 in the horizontal direction, from the smallest resolved azimuth angle to the largest resolved azimuth angle. In addition, the collected light is dispersed across the detector according to angle of incidence in the vertical direction. The full collection NA in the AOI direction (NA_{AOI}) spans the detector surface in the vertical direction, and the full collection NA in the Azimuth direction (NA_{AZ}) spans the detector surface in the horizontal direction.

As depicted in FIG. 1, ellipsometric imaging system 100 includes a specimen positioning system 102 that moves specimen 101 within the field of view of imaging detector 140. In some embodiments, specimen positioning system 102 moves specimen 101 in a scanning motion in the X-direction. In this manner, the field of view of imaging detector 140 moves across the specimen in the X-direction.

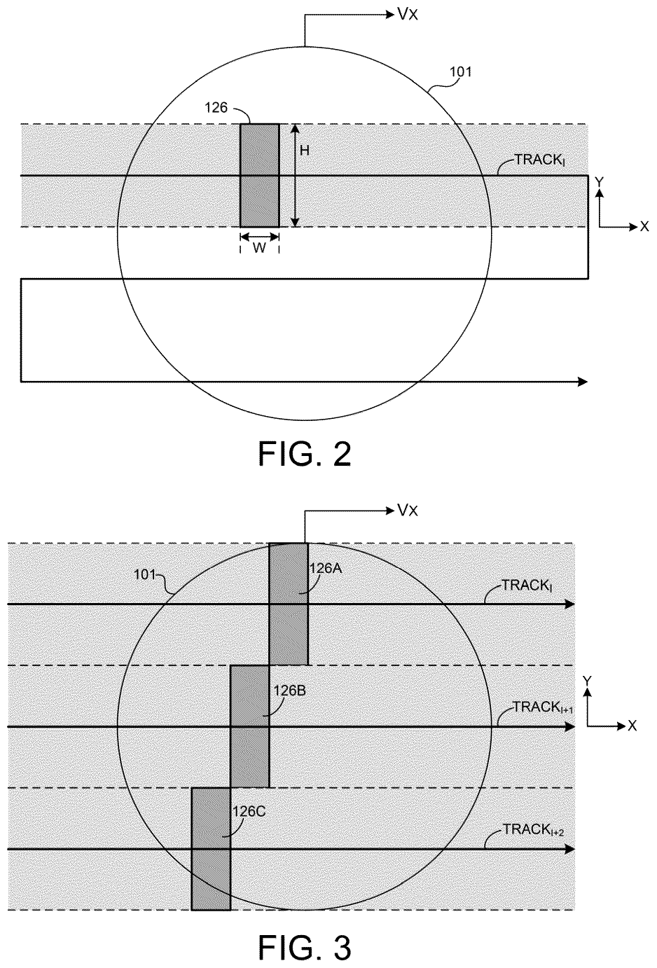

In an exemplary operational scenario, inspection begins with specimen 101 entering the field of view of detector 140. Due to the translation of specimen 101 in the X-direction by specimen positioning system 102, the locus of inspection locations detected within the field of view of imaging detector 140 traces a swath across the surface of specimen 101 in the X-direction. The swath on the surface of specimen 101 is referred to as an inspection track. FIG. 2 depicts inspection location within the field of view of imaging detector 140 at an instant in time. Inspection track, Track₁, illustrates the swath of imaged area across the surface of specimen 101 due to a single scan in the X-direction. In some embodiments, specimen positioning system 101 repeatedly translates specimen 101 in the Y-direction, and scans specimen 101 in the X direction to inspect the entire area of specimen 101.

In general, specimen 101 may be moved across the fields of view of imaging detector 140 in many other operational modes. In some embodiments, specimen positioning system 102 is a rotational stage system that rotates specimen 101 about a center of rotation and translates the center of rotation such that the inspection track is a spiral pattern. In some embodiments, specimen 101 is moved in a stepwise fashion. In these embodiments, specimen 101 is moved to a position, measured, moved to another position, measured, in a repeated manner until the area of specimen 101 is imaged by detector 140.

In some embodiments, additional sets of imaging detectors are employed to improve throughput. For example, FIG. 3 illustrates inspection locations 126A-C associated with the fields of view of three different imaging detectors. The locus of inspection locations detected within the field of view of one imaging detector traces a swath associated with Track₁. The locus of inspection locations detected within the field of view of another imaging detector traces a swath associated with Track₁+1. The locus of inspection locations detected within the field of view of yet another imaging detector traces a swath associated with Track₁₊₂. All three imaging detectors collect image data simultaneously as specimen 101 is translated in the X-direction by specimen positioning system 102. In the embodiment depicted in FIG. 3, specimen positioning system 101 scans specimen 101 in the X direction one time to inspect the entire area of specimen 101.

In the embodiments described with reference to FIG. 2 and FIG. 3, a measured area of specimen 101 is moved across the field of view of one imaging detector. In general, however, a measured area of specimen 101 may be moved across the field of view of any number of different imaging detectors to image a measured area of specimen 101. In some embodiments, a multiple zone imaging detector device includes multiple, small imaging detector zones (e.g., single pixel column resolution) that generate a large number of images of each measured location on specimen 101. In one embodiment, a two dimensional CMOS detector is subdivided into multiple, small imaging detector zones. Since each pixel of a CMOS detector is independently addressable, images are collected independently by separate detector electronics associated with each of the imaging detector zones.

In some embodiments, ellipsometric imaging system 100 may include a deflector (not shown) that scans an illumination beam over the surface of specimen 101 instead of, or in addition to, the movement of specimen 101 by specimen positioning system 102. In one embodiment, the deflector may be an acousto-optical deflector (AOD). In other embodiments, the deflector may include a mechanical scanning assembly, an electronic scanner, a rotating mirror, a polygon based scanner, a resonant scanner, a piezoelectric scanner, a galvo mirror, or a galvanometer. The deflector scans the light beam over the specimen. In some embodiments, the deflector may scan the light beam over the specimen at an approximately constant scanning speed.

As depicted in FIG. 2, the measurement areas 126 within the field of view of imaging detector 140 is characterized by a height, H, and a width, W. In general, H and W may be any suitable dimensions. In some examples, H extends over a relatively large number of image pixels and W is the width of a single pixel. In other examples, W is the width of multiple pixels, and imaging detector 140 collects light over a two dimensional array of pixels. In some examples, H, may extend all the way across specimen 101 (e.g., at least 300 millimeters). In some examples, W, may also extend all the way across specimen 101 (e.g., at least 300 millimeters).

In some embodiments, imaging detector 140 is a charge-coupled device (CCD) detector. In some embodiments, imaging detector 140 is a complementary metal on silicon (CMOS) detector.

In some embodiments, imaging detector 140 is integrated into a multiple zone detector device. In some other embodiments, multiple imaging detectors are each stand-alone devices.

In preferred embodiments, imaging detector 140 operates in a time delay integration (TDI) mode to increase signal to noise ratio. In these embodiments, each measurement location is measured by each detector pixel across the width dimension, W, and the measured signals associated with each measurement location are summed to arrive at the image signal associated with each particular measurement location. When TDI detection is employed, ellipsometric imaging as described herein cannot be realized with continuous rotation of any of the illumination polarizer, waveplate in the imaging path, and analyzer in the imaging path.

In some embodiments, imaging detector 140 operates in a step and flash mode or scan and flash mode. In some embodiments, imaging detector 140 operates in a line scanning mode (e.g., field of view having a width of one pixel scanned across the specimen).

In the embodiment depicted in FIG. 1, the retardation of waveplate 120, the clocking angle of waveplate 120, and the clocking angle of analyzer 121 are adjustable parameters optimized for a particular inspection application to maximize defect signal to image noise ratio. In the embodiment depicted in FIG. 1, command signal 146 is communicated to analyzer 121. Analyzer 121 includes an actuator subsystem (not shown) configured to change the clocking angle of analyzer 121 in accordance with command signal 146 communicated from computing system 130. In some embodiments, the actuator subsystem is a rotary stage capable of rotating analyzer 121 about an axis aligned with the direction of propagation of collected light 127 through analyzer 121. Similarly, command signal 144 is communicated to waveplate 120. Waveplate 120 includes an actuator subsystem (not shown) configured to change the clocking angle of waveplate 120 in accordance with command signal 144 communicated from computing system 130. In some embodiments, the actuator subsystem is a rotary stage capable of rotating waveplate 120 about an axis aligned with the direction of propagation of collected light 127 through waveplate 120. In addition, command signal 145 is communicated to waveplate 120. In some embodiments, waveplate 120 includes an actuator subsystem (not shown) configured to change the wedge angle of waveplate 120, which, in turn, changes the retardance of waveplate 120 in accordance with command signal 145 communicated from computing system 130. In some other embodiments, waveplate 120 includes a controlled voltage source that applies electrical voltage to a liquid crystal material (not shown), which, in turn, changes the retardance of waveplate 120 in accordance with command signal 145 communicated from computing system 130.

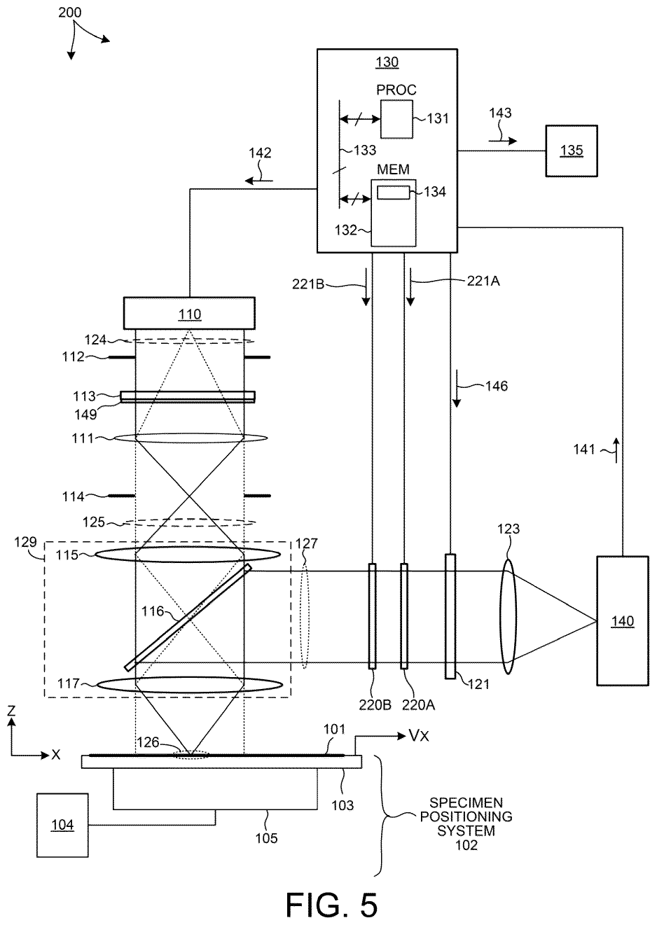

FIG. 5 is a simplified diagram illustrative of another embodiment of an ellipsometric imaging system 200 useful for defect inspection of semiconductor wafers and reticles. Like numbered elements are analogous to those described with reference to FIG. 1. In the embodiment depicted in FIG. 5, ellipsometric imaging system 200 includes waveplates 220A and 220B in the imaging path. In the embodiment depicted in FIG. 5, waveplates 220A and 220B each have a different, fixed retardance. In this embodiment, the clocking angle of waveplate 120A, the clocking angle of waveplate 120B, and the clocking angle of analyzer 121 are adjustable parameters optimized for a particular inspection application to maximize defect signal to image noise ratio.

In the embodiment depicted in FIG. 5, command signal 221A is communicated to waveplate 220A. Waveplate 220A includes an actuator subsystem (not shown) configured to change the clocking angle of waveplate 220A in accordance with command signal 221A communicated from computing system 130. In some embodiments, the actuator subsystem is a rotary stage capable of rotating waveplate 220A about an axis aligned with the direction of propagation of collected light 127 through waveplate 220A. Similarly, command signal 221B is communicated to waveplate 220B. Waveplate 220B includes an actuator subsystem (not shown) configured to change the clocking angle of waveplate 220B in accordance with command signal 221B communicated from computing system 130. In some embodiments, the actuator subsystem is a rotary stage capable of rotating waveplate 220B about an axis aligned with the direction of propagation of collected 127 through waveplate 220B.

FIG. 5 also depicts optional quarter wave plate 149 in the illumination path after polarizing component 113. In some embodiments, quarter wave plate 149 is not located in the illumination path. In these embodiments, illumination light 125 is linearly polarized as dictated by polarizing element 113. In a preferred embodiment, the illumination polarization is linear and set in the 45° direction. In some other embodiments, quarter wave plate 149 is located in the illumination path. In these embodiments, illumination light 125 is circularly polarized.

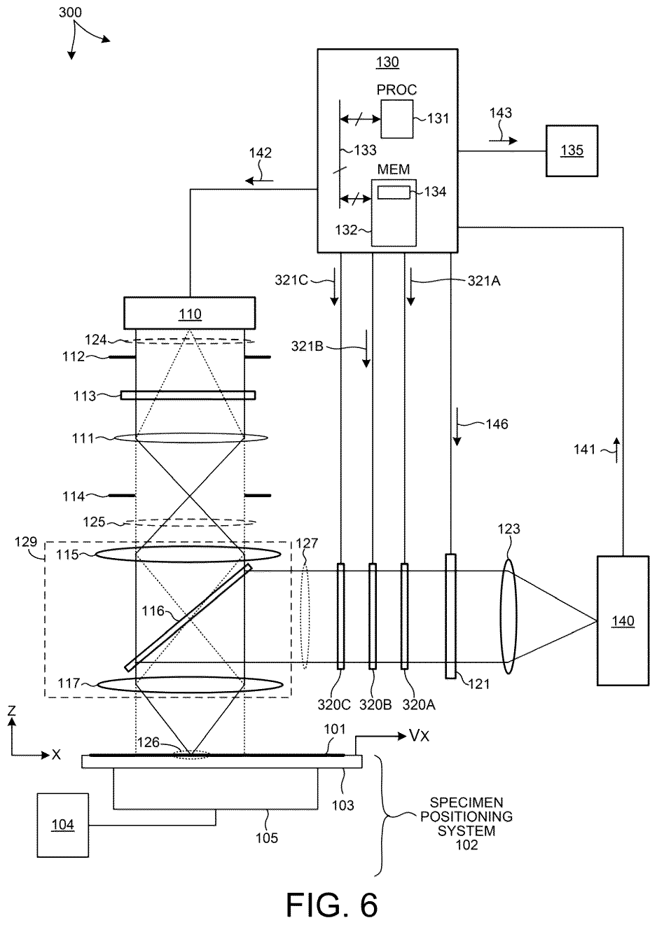

FIG. 6 is a simplified diagram illustrative of another embodiment of an ellipsometric imaging system 300 useful for defect inspection of semiconductor wafers and reticles. Like numbered elements are analogous to those described with reference to FIG. 1. In the embodiment depicted in FIG. 6, ellipsometric imaging system 300 includes three waveplates 320A-C in the imaging path. In the embodiment depicted in FIG. 6, waveplates 320A-C each have a different, fixed retardance. In this embodiment, the clocking angle of waveplate 320A, the clocking angle of the waveplate 320B, the clocking angle of waveplate 320C, and the clocking angle of analyzer 121 are adjustable parameters optimized for a particular inspection application to maximize defect signal to image noise ratio.

In the embodiment depicted in FIG. 6, command signal 321A is communicated to waveplate 320A. Waveplate 320A includes an actuator subsystem (not shown) configured to change the clocking angle of waveplate 320A in accordance with command signal 321A communicated from computing system 130. In some embodiments, the actuator subsystem is a rotary stage capable of rotating waveplate 320A about an axis aligned with the direction of propagation of collected light 127 through waveplate 320A.

Similarly, command signal 321B is communicated to waveplate 320B. Waveplate 320B includes an actuator subsystem (not shown) configured to change the clocking angle of waveplate 320B in accordance with command signal 321B communicated from computing system 130. In some embodiments, the actuator subsystem is a rotary stage capable of rotating waveplate 320B about an axis aligned with the direction of propagation of collected 127 through waveplate 320B. Command signal 321C is communicated to waveplate 320C. Waveplate 320C includes an actuator subsystem (not shown) configured to change the clocking angle of waveplate 320C in accordance with command signal 321C communicated from computing system 130. In some embodiments, the actuator subsystem is a rotary stage capable of rotating waveplate 320C about an axis aligned with the direction of propagation of collected 127 through waveplate 320C.

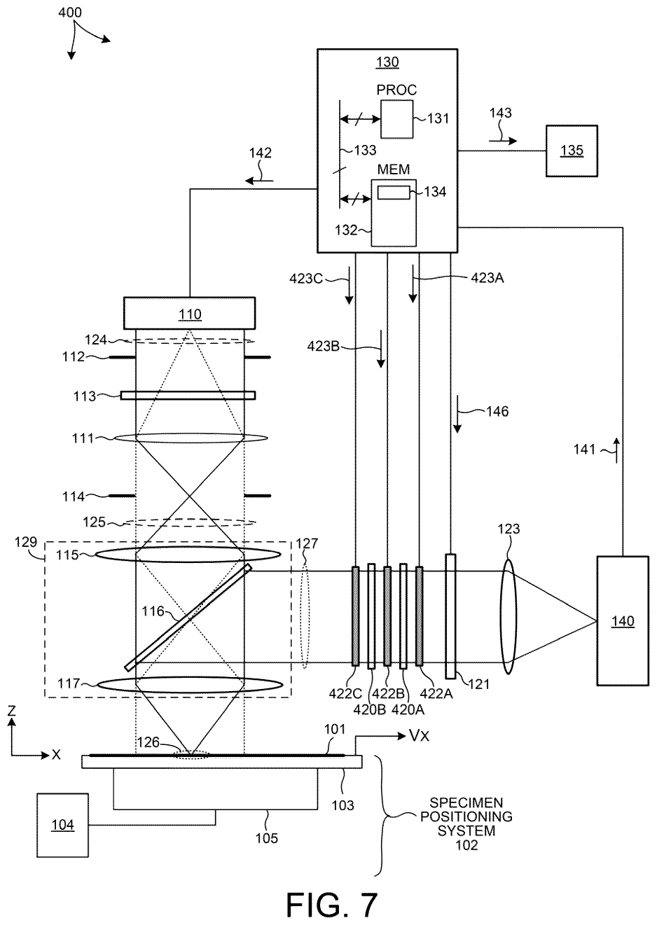

FIG. 7 is a simplified diagram illustrative of another embodiment of an ellipsometric imaging system 400 useful for defect inspection of semiconductor wafers and reticles. Like numbered elements are analogous to those described with reference to FIG. 1. In the embodiment depicted in FIG. 7, ellipsometric imaging system 400 includes waveplates 420A-B and retarders 422A-C in the imaging path. Waveplates 420A-B are interspersed between retarders 422A-C as depicted in FIG. 7. In the embodiment depicted in FIG. 7, retarders 422A-C each have adjustable retardance. Retarders 422A-C are oriented such that the slow axes of retarders 422A-C are aligned. In the embodiment depicted in FIG. 7, waveplates 420A-B each have a fixed retardance. In the embodiment depicted in FIG. 7, waveplates 420A-B are quarter waveplates each having retardance of 90 degrees. Furthermore, waveplates 420A-B each have a fixed, non-adjustable clocking angle. In the embodiment depicted in FIG. 7, waveplates 420A-B are oriented at a clocking angle of 90 degrees with respect to each other, e.g., one of waveplate 420A or 420B at a clocking angle of +45 degrees with respect to the slow axis of the retarders 422A-C and the other of waveplate 420A or 420B at a clocking angle of −45 degrees with respect to the slow axes of retarders 422A-C. As depicted in FIG. 7, command signals 423A-C are communicated to retarders 422A-C. In some embodiments, each of retarders 422A-C includes a controlled voltage source that applies electrical voltage to a liquid crystal material (not shown), which, in turn, changes the retardance of retarders 422A-C in accordance with command signals 423A-C, respectively, communicated from computing system 130. In the embodiment depicted in FIG. 7, the orientation of the assembly of waveplates 420A-B and retarders 422A-C remains fixed in the imaging path. This reduces the mechanical complexity of the optical components in the imaging path.

In a further aspect, the adjustable system parameters of an ellipsometric imaging system are optimized to provide the highest defect signal to wafer noise ratio.

In some embodiments, a rigorous coupled wave analysis (RCWA) is employed to simulate images generated by an ellipsometric imaging system for various combinations of the adjustable system parameters, e.g., the retardation of waveplate 120, the clocking angle of the waveplate 120, and the clocking angle of analyzer 121 for the embodiment depicted in FIG. 1, the clocking angle of waveplate 120A, the clocking angle of waveplate 120B, and the clocking angle of analyzer 121 for the embodiment depicted in FIG. 5, etc. In some examples, the optimal recipe is selected as the recipe having the highest defect signal to wafer noise ratio. In one of these examples, a 3-dimensional grid search is performed where the clocking angles of analyzer 121 and waveplate 120 are varied between −pi/2 to +pi/2 in incremental steps of pi/8, and waveplate retardance is varied between −pi to +pi in incremental steps of pi/18. In some examples, the RCWA simulation is performed under the assumption that the waveplate 120 and analyzer 121 are combined into one Jones pupil, and the Jones matrix is the same at all points in the pupil plane and for all wavelengths. The RCWA simulation is performed for an imaged area of 800 nanometers by 800 nanometers. In some examples, the RCWA simulation is performed using the PROLITH® simulation software commercially available from KLA Corporation, Milpitas, California (USA).

In some other embodiments, actual images of a sample having a known defect are generated by an ellipsometric imaging system for various combinations of adjustable system parameters. The images are evaluated to identify the combination of adjustable parameter values that results in the highest defect signal to wafer noise ratio. In one example, a 3-dimensional grid search is performed where the clocking angles of analyzer 121 and waveplate 120 are varied between −pi/2 to +pi/2 in incremental steps of pi/8, and waveplate retardance is varied between −pi to +pi in incremental steps of pi/18.

In some embodiments, illumination light polarization is treated as an adjustable system parameter. In some of these embodiments, a range of linear polarization angles is evaluated and circular polarization is evaluated.

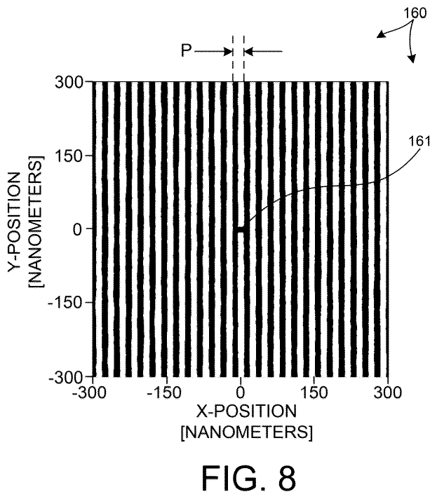

FIG. 8 is an image 160 of a line/space grating including a defect of interest. As depicted in FIG. 8, the line/space grating structure has a pitch of 24 nanometers and includes a defect of interest 161 at a location corresponding to the {x, y} coordinate values of (0,0). The line/space grating structure is a silicon oxide line/space structure, and the defect of interest is a blocked trench. The standard deviation of the line edge roughness of the grating structure is 0.5 nanometers, i.e., wafer noise is 0.5 nanometers. In addition, the exponential correlation length is 20 nanometers.

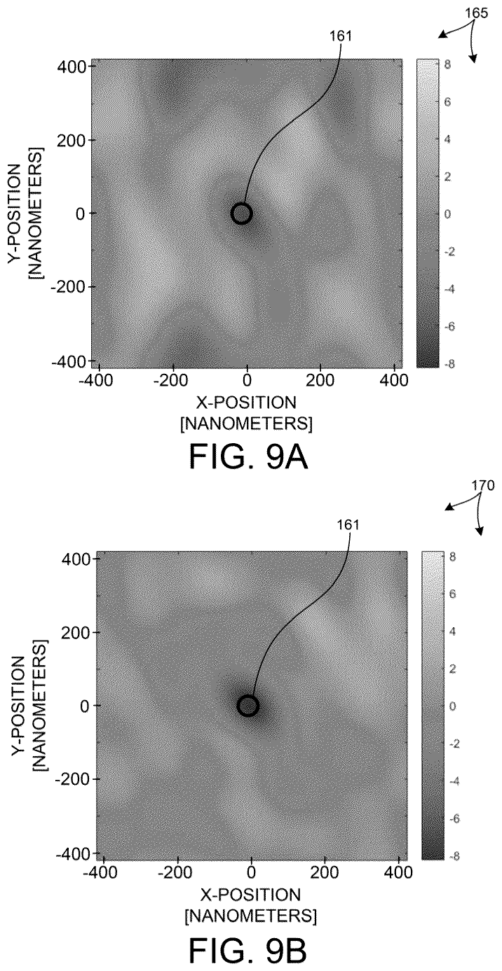

FIG. 9A is an image 165 of line/space grating 160 collected by an imaging system with horizontal illumination polarization (x-polarization only) and no waveplates and no analyzer in the imaging path. In this example, the maximum defect signal to wafer noise ratio achieved is 1.08 and the defect signal intensity is 3.120, i.e. 3.12 multiplied by the standard deviation of all of the pixel intensities of image 165.

FIG. 9B is an image 170 of line/space grating 160 collected by the ellipsometric imaging system depicted in FIG. 1. In this example, linear polarization at 45 degrees is implemented, and the waveplate retardation, waveplate orientation, and analyzer orientation are optimized to achieve the maximum defect signal to wafer noise ratio. In this example, the maximum defect signal to wafer noise ratio achieved is 2.64 and the defect signal intensity is 7.446, i.e. 7.44 multiplied by the standard deviation of all of the pixel intensities of image 170. Thus, both signal to noise ratio and contrast are significantly improved by employing ellipsometric imaging as described herein.

In a further aspect, ellipsometric imaging system 100 also includes computing system 130 configured to receive detected images, identify one or more defects of interest on the imaged specimen over the imaged area based on the intensity values of the detected image, and determine a map of defect locations. As depicted in FIG. 1, computing system 130 receives a detected image 141 from imaging detector 140 and determines a location of one or more defects on specimen 101. Moreover, computing system 130 communicates signals 143 indicative of the determined defect locations to memory 135. Memory 135 stores the defect locations for further analysis, reporting, etc.

In some embodiments, computing system 130 identifies one or more defects of interest on the imaged specimen over the imaged area based on a comparison of each intensity value and a predetermined threshold value. In one example, each pixel having a value below a predetermined threshold value is considered a potential defect. In some examples, the intensity values of a small group of pixels, e.g., a small area of fixed size, are averaged and if the average value is below a predetermined threshold value, a potential defect is identified in the center of the evaluated area. In some examples, gradient information is evaluated at each pixel location, e.g., difference in pixel intensity between adjacent pixels, to identify potential defects. In general, any suitable defect identification scheme is contemplated within the scope of this patent document.

In another further aspect, computing system 130 identifies one or more defects of interest on the imaged specimen over the imaged area based on a difference image. The difference image is a pixel by pixel difference between the detected image and a defect-free reference image. In this manner, signal contrast is enhanced.

In some examples, a defect-free, reference image is generated by averaging the pixel intensities associated with a large number of images each collected from different instances of a specimen. In these examples, the presence of a defect at a particular pixel location is relatively rare. In other words, if a defect is found at a particular location on one specimen, it is likely that the defect will not appear at the same location for many other instances of the same nominal specimen. Thus, by averaging the pixel intensities across many instances of the same nominal specimen, the contribution of a defect found at a particular location is vanishingly small. Thus, the averaged image is effectively defect-free.

Defect detection of some objects is enhanced based on differential images because the differences between images of the same location are highlighted in a differential image. The enhancement of defect detection is particularly apparent when measurement conditions, such as environmental conditions at the wafer, measurement system configuration, etc., are changed between measurements.

In general, a collection optics subsystem may direct light to more than one detector. In some of these embodiments, two or more detectors are each configured to detect collected light over different wavelength ranges, simultaneously. In some embodiments, the detection subsystem is arranged such that the collected light propagates to all detectors, simultaneously.

In general, a dispersive element may be configured to subdivide the incident light into different wavelength bands and propagate the different wavelength bands in different directions in any suitable manner.

In some examples, ellipsometric imaging system 100 includes detectors such as lead sulfide (PbS), lead selenide (PbSe), indium antimonide (InSb), indium arsenide (InAs), mercury cadmium telluride (HgCdTe), indium gallium arsenide (InGaAs), x-InGaAs, pyroelectric, and bolometric detectors. Pyroelectric and bolometric detectors are not quantum detectors. Thus, these detectors may accept high light levels without saturation, and thus reduce noise sensitivity.

In some embodiments, the detector subsystem is shot noise limited, rather than dark noise limited. In these examples, it is preferred to perform measurements at high light levels to reduce measurement system noise.

In some embodiments, one or more of the detectors are cooled to temperatures of −20° C., 210° K, 77° K, or other low temperature to reduce measurement noise. In general, any suitable cooling element may be employed to maintain the temperature of a detector at a constant temperature during operation. By way of non-limiting example, any of a multi stage Peltier cooler, rotating disc cooler, Stirling cycle cooler, N2 cooler, He cooler, etc. may be contemplated within the scope of this patent document.

In another further aspect, the dimensions of illumination pupil stop and the dimensions of the collection mask are adjusted to optimize the resulting measurement accuracy and speed based on the nature of target under measurement.

In the embodiment depicted in FIG. 1, computing system 130 is configured to receive signals 141 indicative of the ellipsometric image detected by detector 140. Computing system 130 is further configured to determine control signals 142 that are communicated to illumination source 110. Illumination source 110 receives control signals 142 and adjusts the illumination power, spectral range, etc. to achieve the desired illumination properties.

Any of the illumination and collection optics described herein may be a lens, a compound lens, or any appropriate lens known in the art. Alternatively, any of the illumination and collection optics described herein may be a reflective or partially reflective optical component, such as a mirror. In addition, although particular collection angles are illustrated in FIG. 1, it is to be understood that the collection optics may be arranged at any appropriate collection angle. The collection angle may vary depending upon, for example, the angle of incidence and/or topographical characteristics of the specimen.

Each imaging detector generally functions to convert the scattered light into an electrical signal, and therefore, may include substantially any photodetector known in the art. However, a particular detector may be selected for use within one or more embodiments of the invention based on desired performance characteristics of the detector, the type of specimen to be inspected, and the configuration of the illumination. For example, if the amount of light available for inspection is relatively low, an efficiency enhancing detector such as a time delay integration (TDI) camera may increase the signal-to-noise ratio and throughput of the system. However, other detectors such as charge-coupled device (CCD) cameras, photodiode arrays, phototube and photomultiplier tube (PMTs) arrays may be used, depending on the amount of light available for inspection and the type of inspection being performed. The term “imaging detector” is used herein to describe a detector having a sensing area, or possibly several sensing areas (e.g., a detector array or multi-anode PMT). Regardless of number, the sensing areas of an imaging detector generate image signals independent from any other imaging detector.

Ellipsometric imaging system 100 also includes various electronic components (not shown) needed for processing the scattered signals detected by imaging detector 140. For example, ellipsometric imaging system 100 may include amplifier circuitry to receive output signals from detector 140, and to amplify those output signals by a predetermined amount and an analog-to-digital converter (ADC) to convert the amplified signals into a digital format suitable for use within processor 131.

In general, processor 131 is configured to detect features, defects, or light scattering properties of the wafer using the detected images. The detected images are generated based on the image signals produced by imaging detector 140. The images may be generated by detector 140 as described hereinbefore, or may be generated by computing system 130 based on the image signals produced by imaging detector 140. The processor may include any appropriate processor known in the art. In addition, the processor may be configured to use any appropriate defect detection algorithm or method known in the art. For example, the processor may use a die-to-database comparison or a thresholding algorithm to detect defects on the specimen.

In addition, ellipsometric imaging system 100 may include peripheral devices useful to accept inputs from an operator (e.g., keyboard, mouse, touchscreen, etc.) and display outputs to the operator (e.g., display monitor). Input commands from an operator may be used by processor 131 to adjust threshold values used to control illumination characteristics, collection characteristics, wafer conditioning characteristics, etc. The resulting characteristics may be graphically presented to an operator on a display monitor.

In the embodiment illustrated in FIG. 1, specimen positioning system 102 moves wafer 101 under a stationary microscope. Specimen positioning system 102 includes a chuck 103, motion controller 104, a X-translation stage 105, and a Y-translation stage (not shown). Specimen 101 is supported on chuck 103. As illustrated in FIG. 1, translation stage 105 translates specimen 101 in the X-direction at a specified velocity, VX, and the Y-translation stage translates specimen 101 in the Y-direction. Motion controller 104 coordinates the movements of specimen 101 by the X and Y translation stages to achieve the desired stepping or scanning motion of specimen 101 within ellipsometric imaging system 100.

As illustrated in FIG. 1, a single primary illumination source 110 supplies the illumination energy for the illumination beam. In some embodiments, illumination source 110 may be a broadband source. The broadband light may be separated into different wavelength bands supplied to different illumination optics to generate illumination beams of different wavelength. Similarly, light collected from the wafer surface may be separated into different wavelength bands and directed to different imaging detectors. As discussed herein, reflected and scattered light collected from the wafer surface may be associated with either illumination beam based on the field of view of each imaging detector. However, distinguishing between reflected and scattered light associated with each illumination beam may also be based on the wavelength of the collected light when different wavelength light is used to generate each illumination beam. In this manner, imaging detector signals originating from different illumination beams may be distinguished even when the fields of view of each imaging detector are located close together on the wafer surface.

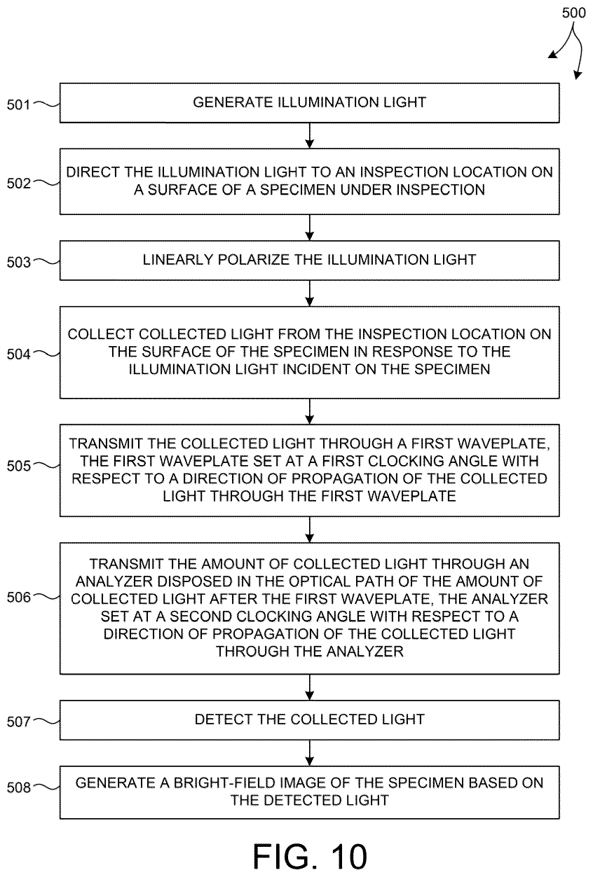

FIG. 10 illustrates a method 500 of performing defect inspection based on ellipsometric images in at least one novel aspect. Method 500 is suitable for implementation by an ellipsometric imaging system such as ellipsometric imaging systems 100, 200, 300, and 400 illustrated in FIG. 1, FIG. 5, FIG. 6, and FIG. 7, respectively, of the present invention. In one aspect, it is recognized that data processing blocks of method 500 may be carried out via a pre-programmed algorithm executed by one or more processors of computing system 130, or any other general purpose computing system. It is recognized herein that the particular structural aspects of systems 100, 200, 300, and 400 do not represent limitations and should be interpreted as illustrative only.

In block 501, illumination light is generated.

In block 502, the illumination light is directed to an inspection location on a surface of a specimen under inspection.

In block 503, the illumination light is linearly polarized.

In block 504, collected light is collected from the inspection location on the surface of the specimen in response to the illumination light incident on the specimen.

In block 505, the amount of collected light is transmitted through a first waveplate. The first waveplate is set at a first clocking angle with respect to a direction of propagation of the collected light through the first waveplate.

In block 506, the amount of collected light is transmitted through an analyzer disposed in the optical path of the amount of collected light after the first waveplate. The analyzer is set at a second clocking angle with respect to a direction of propagation of the collected light through the analyzer.

In block 507, the collected light is detected.

In block 508, a bright-field image of the specimen is generated based on the detected light.

In a further embodiment, systems 100, 200, 300, and 400 include one or more computing systems 130 employed to perform defect inspection of actual device structures based on ellipsometric images collected in accordance with the methods described herein. The one or more computing systems 130 may be communicatively coupled to the detector. In one aspect, the one or more computing systems 130 are configured to receive image data associated with images of the structure of the specimen under inspection.

It should be recognized that one or more steps described throughout the present disclosure may be carried out by a single computer system 130 or, alternatively, a multiple computer system 130. Moreover, different subsystems of systems 100, 200, 300, and 400, may include a computer system suitable for carrying out at least a portion of the steps described herein. Therefore, the aforementioned description should not be interpreted as a limitation on the present invention but merely an illustration.

In addition, the computer system 130 may be communicatively coupled to the detector in any manner known in the art. For example, the one or more computing systems 130 may be coupled to computing systems associated with the detector. In another example, the detector may be controlled directly by a single computer system coupled to computer system 130.

The computer system 130 of systems 100, 200, 300, and 400 may be configured to receive and/or acquire data or information from the subsystems of the system (e.g., detectors and the like) by a transmission medium that may include wireline and/or wireless portions. In this manner, the transmission medium may serve as a data link between the computer system 130 and other subsystems of systems 100, 200, 300, and 400.

Computer system 130 of systems 100, 200, 300, and 400 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board systems 100, 200, 300, and 400, external memory, or other external systems). For example, the computing system 130 may be configured to receive measurement data from a storage medium (i.e., memory 132 or an external memory) via a data link. For instance, imaging results obtained using the detector described herein may be stored in a permanent or semi-permanent memory device (e.g., memory 132 or an external memory). In this regard, the imaging results may be imported from on-board memory or from an external memory system. Moreover, the computer system 130 may send data to other systems via a transmission medium. For instance, a map of defect locations 143 determined by computer system 130 may be communicated and stored in an external memory. In this regard, inspection results may be exported to another system.

Computing system 130 may include, but is not limited to, a personal computer system, mainframe computer system, cloud based computing system, workstation, image computer, parallel processor, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

Various embodiments are described herein for a semiconductor imaging system that may be used for inspecting a specimen within any semiconductor processing tool (e.g., an inspection system or a lithography system). The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO₂. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An ellipsometric imaging system comprising:
an illumination source configured to generate illumination light, the illumination light incident at an inspection location on a surface of a specimen under inspection;
an illumination polarizer located in an illumination optical path between the illumination source and the specimen under inspection, wherein the illumination polarizer polarizes the illumination light incident on the specimen;
an objective configured to collect collected light from the inspection location on the surface of the specimen in response to the illumination light incident on the specimen;
a first waveplate in an optical path of the collected light, the first waveplate set at a first clocking angle with respect to a direction of propagation of the collected light through the first waveplate;
an analyzer disposed in the optical path of the collected light after the first waveplate, the analyzer set at a second clocking angle with respect to a direction of propagation of the collected light through the analyzer; and
an imaging detector having a surface sensitive to the collected light incident on the surface, the imaging detector configured to generate a bright-field image of the specimen.

2. The ellipsometric imaging system of claim 1, wherein the specimen is a semiconductor wafer or a reticle.

3. The ellipsometric imaging system of claim 1, wherein a retardance of the first waveplate is adjustable.

4. The ellipsometric imaging system of claim 1, further comprising:
a second waveplate in the optical path of the collected light, the second waveplate set at a third clocking angle with respect to a direction of propagation of the collected light through the second waveplate, the second waveplate disposed in the optical path of the collected light between the first waveplate and the analyzer.

5. The ellipsometric imaging system of claim 4, wherein a retardation of the first waveplate is fixed at a first value and a retardation of the second waveplate is fixed at a second value, wherein the first and second values are different.

6. The ellipsometric imaging system of claim 4, further comprising:
a third waveplate in the optical path of the collected light, the third waveplate set at a fourth clocking angle with respect to a direction of propagation of the collected light through the third waveplate, the third waveplate disposed in the optical path of the collected light between the second waveplate and the analyzer.

7. The ellipsometric imaging system of claim 4, further comprising:
an first optical retarder having adjustable retardance, the first optical retarder disposed in the optical path of the collected light between the specimen and the first waveplate;
a second optical retarder having adjustable retardance, the second optical retarder disposed in the optical path of the collected light between the first waveplate and the second waveplate; and
a third optical retarder having adjustable retardance, the third optical retarder disposed in the optical path of the collected light between the second waveplate and the analyzer, wherein the first and second waveplates are quarter waveplates, and wherein the first clocking angle and the third clocking angle are fixed.

8. The ellipsometric imaging system of claim 1, wherein the illumination polarizer is a linear polarizer.

9. The ellipsometric imaging system of claim 8, wherein the amount of illumination light incident on the specimen polarized at 45 degrees.

10. The ellipsometric imaging system of claim 1, further comprising:
a quarter waveplate disposed in the illumination path between the illumination polarizer and the specimen under inspection, wherein the illumination light incident on the specimen is circularly polarized.

11. The ellipsometric imaging system of claim 1, wherein the bright-field image of the specimen is a field image.

12. The ellipsometric imaging system of claim 11, wherein the imaging detector is a time domain integration (TDI) detector.

13. The ellipsometric imaging system of claim 1, wherein the bright-field image of the specimen is a pupil image.

14. The ellipsometric imaging system of claim 1, further comprising:
a computing system configured to:
receive the detected bright-field image;
identify one or more defects of interest based at least in part on the detected bright-field image; and
determine a map of locations of the one or more identified defects of interest corresponding to the specimen.

15. The ellipsometric imaging system of claim 14, wherein the identifying of the one or more defects of interest involves:
determining a difference image, wherein the difference image is a pixel by pixel difference in intensity values between the detected bright-field pupil image a defect-free reference image; and
identifying the one or more defects of interest based on pixel intensity values of the difference image.

16. The ellipsometric imaging system of claim 15, wherein the defect-free, reference image is generated by pixel by pixel averaging of a plurality of detected bright field pupil images each associated with a different instance of the specimen.

17. A method comprising:
generating illumination light;
directing the illumination light to an inspection location on a surface of a specimen under inspection;
linearly polarizing the illumination light;
collecting collected light from the inspection location on the surface of the specimen in response to the illumination light incident on the specimen;
transmitting the collected light through a first waveplate, the first waveplate set at a first clocking angle with respect to a direction of propagation of the collected light through the first waveplate;
transmitting the amount of collected light through an analyzer disposed in the optical path of the collected light after the first waveplate, the analyzer set at a second clocking angle with respect to a direction of propagation of the collected light throughout the analyzer;
detecting the collected light; and
generating a bright-field image of the specimen based on the detected light.

18. The method of claim 17, further comprising:
identifying one or more defects of interest based at least in part on the detected bright-field image; and
determining a map of locations of the one or more identified defects of interest corresponding to the specimen.

19. The method of claim 18, wherein the identifying of the one or more defects of interest involves:
determining a difference image, wherein the difference image is a pixel by pixel difference in intensity values between the detected bright-field pupil image a defect-free reference image; and
identifying the one or more defects of interest based on pixel intensity values of the difference image.

20. An ellipsometric imaging system comprising:
an illumination source configured to generate illumination light, the illumination light incident at an inspection location on a surface of a specimen under inspection;
an illumination polarizer located in an illumination optical path between the illumination source and the specimen under inspection, wherein the illumination polarizer polarizes the illumination light incident on the specimen;
an objective configured to collect collected light from the inspection location on the surface of the specimen in response to the illumination light incident on the specimen;
a first waveplate in an optical path of the collected light, the first waveplate set at a first clocking angle with respect to a direction of propagation of the collected light through the first waveplate;
an analyzer disposed in the optical path of the collected light after the first waveplate, the analyzer set at a second clocking angle with respect to a direction of propagation of the collected light through the analyzer;
an imaging detector having a surface sensitive to the collected light incident on the surface, the imaging detector configured to generate a bright-field image of the specimen; and
a non-transitory, computer-readable medium storing instructions that, when executed by one or more processors, causes the one or more processors to:
identify one or more defects of interest based at least in part on the detected bright-field image; and
determine a map of locations of the one or more identified defects of interest corresponding to the specimen.
